(19) United States
(12) Patent Application Publication
(10) Pub. No.: US 2012/0313271 A1
(43) Pub. Date: Dec. 13, 2012

(54) METHOD FOR PRODUCING SORBENT MATERIALS

(76) Inventor: Stanislaw ROGUT, Pyrzyce (PL)

(21) Appl. No.: 13/492,881

(22) Filed: Jun. 10, 2012

(30) Foreign Application Priority Data
Jun. 10, 2011 (PL) P.395214

(51) Int. Cl. C01B 31/00

(52) U.S. Cl. 264/29.4; 264/29.6

(57) ABSTRACT

A method of producing carbon-based sorbent by (a) mixing carbon-containing raw materials with group I, II, and/or III oxides and/or hydroxides; (b) carbonizing at low temperatures of between 100° C. and 280° C.; followed by carbonizing at high temperatures of between 280° C. and 500° C., whereby simultaneously dehydrating the hydrates and releasing superheated dry steam at high temperature exceeding 500° C.; and (c) directing the superheated dry steam against the direction of the feed flow.

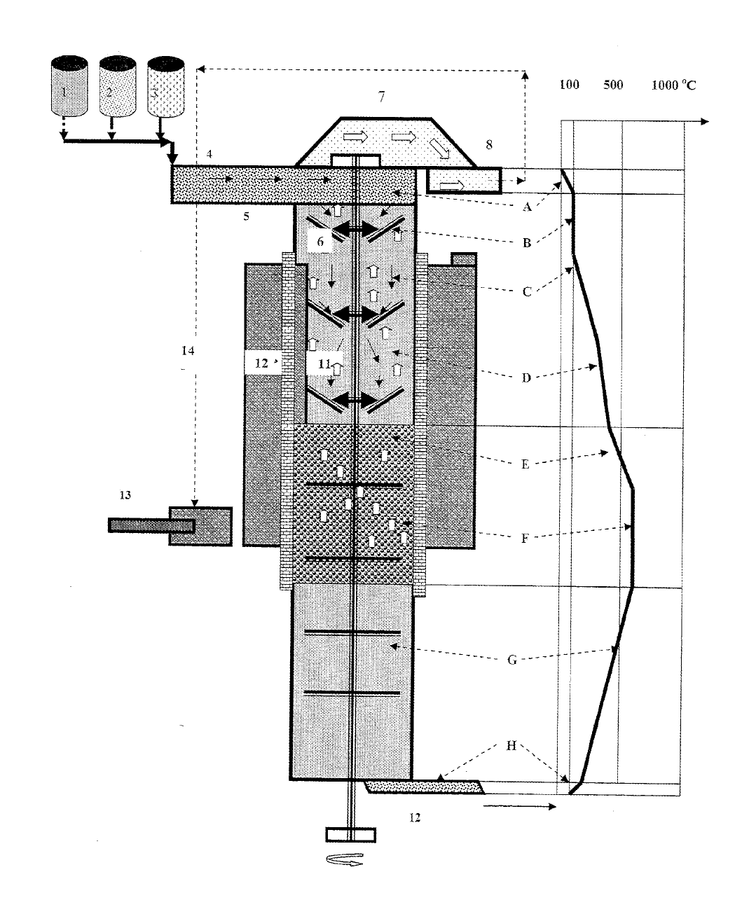

### CROSS-REFERENCE TO RELATED APPLICATIONS

This application claims foreign priority benefits to Polish Patent Application No. P.395214 filed Jun. 10, 2011, the contents of which, including any intervening amendments thereto, are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, Tex. 77079.

### BACKGROUND OF THE INVENTION

1. Field of the Invention

The invention relates to sorbent materials, i.e., materials used to absorb substances, such as liquids or gases, and to a method of producing carbon-based sorbent materials from carbon-containing raw materials.

2. Description of the Related Art

Known methods of converting carbon-containing raw materials into carbon-based sorbent materials consist of thermal treatment by low-temperature carbonization, including refinement of the by-products using the same process.

The treatment process is conducted in one or in several successive unit operations and in one or in several reactors forming a process system.

The material is first dried and then subjected to low-temperature carbonization under controlled conditions. This is followed by carbonization of the dry remains to yield a product having desired properties.

The majority of methods for producing carbon-based sorbents is based on low-temperature carbonization of biomass of agricultural or forest origin, and especially biomass containing a large amount of lignocellulose. Typical raw materials used in these processes include various types of wood, coconut shells, etc. The processes are performed in several stages.

In the first stage, dried biomass is subjected to low-temperature carbonization at below 300° C. and in the absence of oxygen, or in the presence of only a small amount of air, to ensure partial carbonization. The product produced in this stage is called torrefied biomass or bio-coal.

In the next stage, carbonization is continued at temperatures above 300° C., preferably between 450° C. to 500° C. Heating of the torrefied biomass at these temperatures continues to decompose lignocellulose and other intermediates resulting in the creation of porous activated carbon structures and liberation of tars.

In order to produce good quality carbon, tar substances produced and lodged between carbon particles need to be removed at this stage by evaporation or by blasting through with inert gases or with steam. Removal of the tars and gaseous products of thermal decomposition from the channels formed between carbon particles yields porous carbon structures.

Detailed descriptions of processes taking place in carbon-containing raw materials and biomass during low-temperature carbonization are described, e.g., in FR 839732, FR 872164, and DE 2802213. According to these patents, boundary temperatures separating low-temperature carbonization from high-temperature carbonization lie between 270° C. to 300° C. At these temperatures, the thermal decomposition of lignocellulose is exothermic. The products of the initial low-temperature carbonization suffer from lack of homogeneous composition and ordered form and possess mediocre functional characteristics.

The basic technical problem created by the previously used methods of low-temperature carbonization is how to effectively supply heat to the reactants. In general, conventional methods of heat exchange, such as convection by hot air, steam, or exhaust gases are used to heat reactants to temperatures at which exothermic decomposition begins to take place. The basic technical and technological problem created, in this case, how to accomplish uniform shrinkage of the decomposing biomass and how to heat it evenly in the various parts of the low-temperature carbonization chamber.

To achieve a product having uniform quality, it is necessary to heat all components of the to be carbonized biomass at constant temperatures and to provide uniformly constant flow of hot gasses through the channels and pores created in the grains of the elemental carbon being formed. Thus, various equipments for distributing hot gases between intermediate particles have been used to create stable and identical conditions for low-temperature carbonization with respect to every grain of the carbon-containing starting material.

For example, EP 0073724 discloses operations for ensuring uniform thermal conditions during low-temperature carbonization and subsequent high-temperature carbonization and for obtaining product having uniform properties and high caloric value. EP 0073724 emphasizes the need to employ hot inert gases such as nitrogen, helium, carbon dioxide, or superheated steam in order to yield high quality product in which the inner cores of the grains are devoid of tars.

Obtaining high quality products using conventional technologies is predicated upon providing initial starting materials having a high degree of fragmentation and homogenization because only such starting material allows for the production of a high quality product and at the same time makes it possible to reduce carbonization times to below 30 minutes, which is particularly economical.

Another factor influencing the quality of products formed during low-temperature carbonization is the provision of constant temperature within a narrow band, preferably between 280° C. and 300° C., such as not to allow for the process to become uncontrollably exothermic (a so-called self-pyrolysis). Only low-temperature carbonization processes of biomass conducted at uniformly controlled temperature conditions allow for economical production of carbon sorbents with the yield reaching about 35 wt. % with respect to the starting raw material.

Modeling studies show that exothermic decomposition of carbonaceous raw materials which is difficult to control begins already at temperatures below 280° C., especially if the starting raw materials contain a large percentage of lignocellulose. Two competing thermochemical processes take place during low-temperature carbonization at between 280° C. and 300° C., the first one being a rapid thermo-condensation which rapidly slows down as this temperature range is approached, and the second one being exothermic carbonization.

If even the smallest amount of oxygen is present in the blasting and heating gases, carbonization becomes difficult to control and complete pyrolysis can occur.

In order to prevent uncontrolled pyrolysis of biomass being carbonized at low temperature, U.S. Pat. No. 4,954,620 proposes using extreme precision of the temperatures during the various carbonization stages. Such amount of precision involves complicated and often unreliable temperature control systems and heating and blasting gas flow control systems. U.S. Pat. No. 4,954,620 emphasizes that obtaining high quality product requires maximal assurance of isothermal conditions such that the temperature gradient between the heating element and the carbonized material does not exceed more than only a few degrees C.

CH 228877, FR 953004, and U.S. Pat. No. 4,553,978, each confirm the necessity of ensuring precise heating conditions and a high degree of material fragmentation during low-temperature carbonization. Each of these specifications emphasizes the enormous influence that precisely controlled temperature conditions and methods of heat transfer to grains of material being carbonized have on the properties of the products obtained.

Carbon sorbents manufactured according to conventional methods are characterized by low absorption profiles due to the fact that the ability to absorb harmful chemicals depends on the size and structure of the absorptive surface and the geometry of the pores formed within the grains of the sorbents during the manufacturing process.

In most cases, conventional carbon sorbents only temporarily bind absorbed substances by physical adsorption, which threatens their release into the gases or liquids flowing through the sorbents when maximum adsorption has occurred or when optimal working temperatures have been exceeded.

A problem which is difficult to solve during the production of sorbents, especially those carbon-based, involves production of sorbents having highly durable spatial structures. Many industrial applications require sorbents having porous granules of high mechanical strength and high abrasion resistance.

Most conventional methods rely on secondary production of granules from previously obtained sorbent materials in high pressure granulators or by adding aggregating agents to powdered sorbents.

### SUMMARY OF THE INVENTION

The purpose of the invention is to solve the existing technological difficulties during production of sorbents by low-temperature and high-temperature carbonization, to improve the efficiency of the processes and the quality of sorbents obtained, and well as to accomplish stable carbonization conditions, and to avoid self-pyrolysis.

In one embodiment of the invention, a method of producing carbon-based sorbent comprises:
(a) thoroughly mixing carbon-containing raw material(s) with reaction-influencing additive(s) and reagent(s), the reaction-influencing additive(s) comprising soluble chemical catalyst(s), particularly of iron, silver, copper, vanadium, and the reagent(s) comprising hydrate(s), and particularly hydrate(s) of group I oxide(s), hydrate(s) of group II oxide(s), and/or hydrate(s) of group III oxide(s), to yield a homogenous intermediate;
(b) continuously feeding the homogenous intermediate into an upper portion of a reactor and allowing the homogeneous intermediate to flow through the reactor toward a lower portion of the reactor;
(c) carbonizing the first homogenous intermediate at low temperatures by evenly heating the upper portion of the reactor to a temperature of between 100° C. and 280° C.; carbonizing at high temperatures by evenly heating the lower portion of the reactor to between 280° C. and 500° C., whereby simultaneously dehydrating the hydrate(s), and forming within the grains of the hydrate(s) autogenous micro reactors, and whereby releasing superheated dry steam at high temperature exceeding 500° C.;
(d) directing the superheated dry steam against the direction of the flow of the homogeneous intermediate;
(e) obtaining carbon-based sorbent in the lower portion of the reactor and continuously removing the carbon-based sorbent from the reactor.

In a class of this embodiment, the superheated dry steam being directed against the flow of the homogeneous intermediate and resulting porous sorbent structures in various (progressive) stages of creating of the final carbon-based sorbent causes a formation of volatile gasses and tars, which are the products of thermal decomposition of the homogeneous intermediate and which flow with the superheated dry steam toward the upper section of the reactor, at which position they come into contact with filters for binding liquid and gaseous impurities, the filters comprising hydrate(s), and particularly hydrate(s) of group I oxide(s), hydrate(s) of group II oxide(s), and/or hydrate(s) of group III oxide(s).

In a class of this embodiment, the superheated dry steam being directed against the flow of the homogeneous intermediate and the resulting channels and pores of the sorbent material being formed causes refinement and activation of the porous surfaces of the sorbent structure.

In certain embodiments of the invention, the homogeneous intermediate fed into the reactor comprises carbon-containing raw material(s) and reagent(s), wherein the carbon-containing raw material(s) are preferably beet sugar (e.g., sugar made from cultivated plants of Beta vulgaris), and particularly in the form of concentrated and purified aqueous solution (syrup), in an amount of between 50% and 90% of sugar w/w with respect to the weight of the homogeneous intermediate, and the reagent(s) are preferably burnt lime, ground, of high reactivity, particularly having t₆₀<2 minutes, in an amount of between 5 and 30%, and particularly 18%, of the burnt lime w/w with respect to the weight of the homogeneous intermediate.

In certain embodiments of the invention, the raw materials and the reagents are added continuously at a constant rate.

In certain embodiments of the invention, the raw materials and the reagents are roasted and thoroughly mixed and the reagents are finely dispersed in the raw materials in the reaction chamber. Thereafter, the resultant mixture is dried and homogenated to yield a homogenous intermediate, which is loose, dry, and granulated and has a homogeneous structure.

In certain embodiments of the invention, after being formed, the homogeneous intermediate is subjected to low-temperature carbonization followed by high-temperature carbonization by passing through it hot gasses generated by combustion of a portion of volatile products obtained during low-temperature carbonization.

In certain embodiments of the invention, the obtained sorbent is transferred to a roasting zone set to about 600° C. for generating porous carbon-containing sorbent of calcined calcium oxide having a significant mechanical strength.

In certain classes of the embodiments, the homogeneous intermediate comprises a dry, ground, and homogeneous mixture of refined (beet) sugar, and between 1.0% and 10% w/w, particularly 5%, of ground burnt lime of high purity and reactivity with respect to the weight of the homogeneous intermediate, and/or between 1.3% and 13% w/w, particularly 6%, of lime hydrate of very high purity with respect to the weight of the homogeneous intermediate.

In certain embodiments of the invention, the raw materials comprise finely divided, homogeneous organic materials having high purity, particularly sugar, starch, cellulose and/or organic substances having uniform chemical structure, alone or in the form of mixtures.

The raw materials combined with oxides or hydrates of group I, II, and/or III elements, particularly calcium oxide or calcium hydroxide, yield at the end of the process carbon-based sorbents having orderly structures.

In certain embodiments of the invention, carbon-containing substances used in the process comprise simple sugars having between 3 and 7 carbon atoms per molecule in the backbone and/or complex sugars being combinations of the simple sugars, particularly glycerin, ribose, deoxyribose, glucose, fructose, mannose, and galactose, as well as, disaccharides, oligosaccharides, or polysaccharides.

In certain embodiments of the invention, to finely divided starting materials, to dry sugar, having a purity of 99.99%, is added 10% w/w of ground, pure burnt lime, of high reactivity, comprising at least 99.9% CaO, or 13% w/w of pure ground lime hydrate comprising at least 99.9% Ca(OH)₂. The starting materials are continuously fed to low-temperature carbonization zone, followed by their movement to high-temperature carbonization zone, while maintaining in the reactor a controlled temperature profile starting at room temperature all the way to 800° C.

The starting materials are transferred between the various reactor zones such that they undergo sequential low-temperature carbonization, high-temperature carbonization, followed by refinement of the obtained porous carbon structures by directing in the direction of the starting materials being introduced (e.g., in the direction from the exit of the reactor toward the entrance of the reactor), a stream of superheated steam generated from thermal decomposition of hydrates present in the feed.

In certain embodiments of the invention, metal oxides or their hydrates (hydroxides) remaining in the product after it is formed are removed by dissolving with solvents, including water, particularly distilled water, and/or diluted aqueous acids, which react with the metal oxides or metal hydroxides present in the sorbents whereby forming salts.

In certain embodiments of the invention, the carbon-containing raw materials subjected to low-temperature and then high-temperature carbonization comprise organic substances comprising aliphatic or aromatic compounds having a high purity and high structural periodicity, preferably refined tars, tar pitch, polymers, and copolymers of cyclic and aliphatic compounds.

In certain embodiments of the invention, heat resistant metal elements in the form of balls, rings, or cylinders of various sizes or the like elements made of heat resistant chemical compounds, such as calcium, aluminum, or magnesium oxides, are added to materials undergoing low-temperature and high-temperature carbonization.

In certain embodiments of the invention, the amount of steam used in the refining process is controlled by changes of the amount of oxide or hydroxide in the raw material feed and the temperature in the refining process is controlled by selecting different metal oxides or hydroxides from among groups I, II or III of the periodic table.

The following are examples of metal oxides or hydroxides from among groups I, II or III of the periodic table: Li₂O, Na₂O, K₂O, Rb₂O, Cs₂O, BeO, MgO, CaO, SrO, BaO, B₂O₃, Al₂O₃, Ga₂O₃, In₂O₃, Tl₂O₃, LiOH, NaOH, KOH, RbOH, CsOH, Be(OH)₂, Mg(OH)₂, Ca(OH)₂, Sr(OH)₂, Ba(OH)₂, B(OH)₃, Al(OH)₃, AlO(OH), Ga(OH)₃, In(OH)₃, Tl(OH)₃, TlOH, and others.

In certain embodiments of the invention, the carbon-containing raw material feed is supplemented by dissolvable hydroxides and oxides of metals having catalytic properties, preferably of zinc, iron, chrome, vanadium, nickel, cobalt, manganese, silver, copper or solutions of colloidal molecules of these metals, preferably in a colloidal form, preferably of nickel, molybdenum, vanadium, silver, gold, or copper.

In certain embodiments of the invention, the carbon-containing raw material feed is supplemented by catalysts and activators of activated carbon, and particularly metals and nonmetals in finely divided form and/or in the form of aqueous solutions of their salts which are soluble in water.

In certain embodiments of the invention, for the low-temperature carbonization introduced is feed comprising: sugar in an amount of between 50% and 90%, and particularly 85%, of sugar w/w with respect to the weight of the feed and calcium oxide in an amount of between 5% and 15%, preferably 10%, of the calcium oxide w/w with respect to the weight of the feed, and magnesium oxide in an amount of between 2% and 10%, preferably 5%, of the magnesium oxide w/w with respect to the weight of the feed.

In certain embodiments of the invention, product of the low-temperature carbonization is finely divided and then mixed with water to yield a 30-50% w/w, particularly 40%, aqueous slurry, followed by passing though the slurry gaseous carbon dioxide until a full conversion of the calcium hydroxide and magnesium hydroxide present in the sorbents into unreactive carbonates, followed by drying and granulating of the resultant product, which comprises in its dry state, 50% of activated carbon w/w and 50% of mineral components w/w, mainly in the form of a mixture of calcium carbonate (finely crystalline) and magnesium carbonate.

In certain embodiments of the invention, to a concentrated sugar syrup comprising between 60% and 90% w/w, particularly 85%, of pure sucrose, and between 10% and 40% w/w, particularly 15%, of water, is added between 0.1 and 2.0% w/w with respect to the concentrated syrup, particularly 0.5%, of elements or compounds as catalysts, particularly zinc, iron, copper, chrome, vanadium, nickel, cobalt, manganese, molybdenum, silver, gold, or platinum in the form of colloidal particles of these elements and/or their chemical compounds, particularly in the form of aqueous salt solutions or aqueous hydroxide solutions. Substances obtained in this way are thickened by the addition of 10% w/w of reactive calcium oxide with respect to the substances.

In certain embodiments of the invention, in order to produce sorbents with spatial structures having high porosity, high mechanical strength, and high abrasion resistance, carrier structures are produced first, particularly from steel fibers made of heat-resistant steel having a cross-section of between 0.1 and 1.0 mm² and of various shapes, particularly of circular, rectangular, oval or polygonal cross-section. The steel fibers are treated in advance with chemical solutions which facilitate adherence of the raw materials. The carrier structures are particularly in form of stricken or woven spatial structures formed into appropriate geometries. The carrier structures are saturated with starting raw materials until they are fully filled. Thereafter, the raw-material filled carrier structures are subjected to low-temperature carbonization to yield porous activated carbon structures, which together with the aforementioned carrier structures, form integrated sorbents.

In certain embodiments of the invention, used in the process are spatial structures of high porosity, high mechanical strength, and high abrasion resistance in the form of porous geometric objects made of natural and/or synthetic minerals, particularly pumice, bentonite, sintered aluminum oxide, or expanded clay aggregate, preferably of ceramic sinters.

As a result of the methods of the invention, a new generation of sorbents has been created having organized and highly repetitive structures. The method is implemented by low-temperature carbonization followed by high-temperature carbonization of carbon-containing raw materials of organic origin in the presence of chemical compounds releasing gaseous substances during low-temperature carbonization.

In certain embodiments of the invention, carbon-containing raw materials used in the process are organic raw materials having a high and a very high level of purity and uniformity, such as biomass, especially agricultural biomass, coal, brown coal, peat, and agricultural byproducts. Sorbents manufactured by methods of the invention have a very high purity and uniformity of the created carbon structures, high chemical reactivity, and ordered repetitive structure.

In certain embodiments of the invention, micro grains of metal oxides or metal hydroxides permanently incorporated into the carbon-based sorbents bind harmful chemical substances, such as HCl, H₂S, H₂SO₄, HF or HCN, and many others, by forming salts, which are poorly soluble or insoluble in the liquids from the flow of which the harmful substances are extracted.

In certain embodiments of the invention, carbon-based sorbents produced by methods of the invention unexpectedly undergo additional physicochemical processes that do not occur in sorbents produced by conventional methods. Specifically, the sorbents of the invention comprise active carbon grain agglomerates, which function to filter harmful substances contained in gases and liquids to be purified, as well as grains of metal oxides and metal hydroxides permanently incorporated into the sorbent structures, which function to bind the harmful substances by converting them into poorly soluble or insoluble salts.

The ability for binding chemical substances by sorbents produced by methods of the invention is adjusted as necessary by varying the amount (ratio) of metal oxides added to substances to be carbonized before they undergo carbonization. Depending on the composition of the raw-materials and the metal oxides, created are sorbents having a wide range of abilities, both qualitative and quantitative, with respect to binding impurities.

Unexpectedly, sorbents prepared by methods of the invention bind heavy metal ions, such as Zn⁺⁺, Pb⁺⁺, Cu⁺⁺, Co⁺⁺, Cr⁺⁺⁺, and precious metal ions, such as Ag⁺, and Au⁺. When placed in a flow stream of waste water containing soluble salts of the above-mentioned metals (sulfates, nitrates, chlorides, cyanides, etc.), soluble chloride, sulfate, nitrate or cyanide ions react with the calcium oxide or calcium hydroxide permanently incorporated in the sorbents and produce salts, wherein a high pH generated within the sorbents (pH>12.0) facilitates conversion of the metal ions into gels of poorly soluble hydroxides.

In certain embodiments of the invention, after the salts of precious metals have been bound, the precious metals can be recovered by combusting the sorbents and purifying the remaining residues.

For certain special uses, one or more metal catalysts, particularly in the form of metal salts, such as AlCl₃, MgCl₂, FeCl₂, FeCl₃, CuCl₂, CrCl₃, as well as substances activating surfaces of the produced sorbents, e.g., phosphoric acid, are admixed to the raw materials. Sorbents produced as a result have catalytic properties useful in many industrial applications.

Another unexpected benefit of the methods of the invention is the ability to produce super pure activated carbons having ordered structures. The inability of the prior art to form carbons, and particularly activated carbons having ordered, highly repeatable microstructures is one of barriers preventing the development of carbon-based nanotechnologies. Conventional carbon-based raw materials used for nanotechnological applications, and produced for example by low-temperature carbonization of wood, waste biomass of agricultural origin, or thermal treatment of soot, etc., do not ensure that carbon micro grains having the necessary level of purity and repeatability of their carbon structures (carbon chains and rings).

In the case of low-temperature and high-temperature carbonization of biomass by methods of the invention starting from carbon-based raw materials having high and very high purity levels and structural organization, the possibility of precisely controlling process parameters, unattainable by conventional methods, allows for the production of carbon materials having a structure mirroring the structure and organization of the starting raw-materials. This is highly beneficial.

### BRIEF DESCRIPTION OF THE DRAWINGS

The sole figure shows an exemplary temperature distribution in the particular zones of the carbonization appliance.

### DETAILED DESCRIPTION OF THE EMBODIMENTS

### EXAMPLE 1

### Method of Producing Carbon-Based Sorbent

Concentrated and purified beet sugar syrup containing 60% w/w of sugar in water was added at a constant rate of 2 Mg/h via the dosing system 4 to the mixer inlet 5. Ground burnt lime of high reactivity (t₆₀<2 minutes) was added from a reagent container 2 via the dosing system 4 to the same mixer 5 at a rate of 18% w/w with respect to the beet sugar syrup.

The reaction mixture was pushed through a drying reactor for drying and homogenization of the mixture by FuelCal® technology. After mixing, components were dried by the heath of the exothermal reaction of water contained in the sugar solution with a reagent containing calcium oxide in the reactor 6 to yield loose, dried, granulated and warmed intermediate having uniform homogenous structure.

Water steam emitted during drying of the sugar syrup was diverted via the dome 7 to cooler 8 where the vapours were condensed.

The intermediate was immediately transferred to the carbonization reactor and carbonized or, alternatively, was transported to a storage container for use in a separate system.

The carbonization reactor in the form of a cylindrical chamber 11 was surrounded by an external heating coil 12. The reactor was heated with hot gases produced during combustion in burner 13 of a portion of gases diverted from the low-temperature carbonization zone by the extraction system 14.

As a result of exothermic processes occurring in the intermediate subjected to low-temperature carbonization or as a result of external heating of the calcination chamber, controlled temperature zones were created in the reactor starting with room temperature at the inlet upper part of the reactor, rising progressively higher, and reaching about 800° C. in the maximum temperature zone, and then dropping in the outlet lower part of the reactor (cooling zone).

As a result of slow movement of the feed through the temperature zones, successive low-temperature carbonization and high-temperature carbonization were occurring.

In inlet upper part of the reactor, the feed was dried with a release of hygroscopic water. Then, the feed was heated to temperatures at which most volatile compounds were released from the sugar.

As the material progressed closer to the middle zone with temperatures exceeding 500° C. the low-temperature carbonization process ceased and high-temperature carbonization process began. In the final phase, high-temperature carbonization was accompanied by intensive decomposition of calcium hydrate contained in the calcined material into calcium oxide and superheated steam.

The superheated steam was directed upwards against the flow of the feed and facilitated removal of volatile materials and gaseous organics released from the carbonized material.

Approaching the maximal temperature zone of about 800° C., the processes of low-temperature carbonization, high-temperature carbonization, and agglomeration of carbon grains with lumps of porous calcium oxide stemming from the decomposition of thermal calcium hydrate, came to a standstill.

The exemplary temperature distribution in particular zones of the carbonization reactor is shown in the sole figure. In the reactor, temperature zones are marked with letters from A to H as follows:
A—transport and the batch heating zone: temperatures starting from room temperature up to100° C.;
B—drying zone: temperature of about 170° C.;
C—endothermic heating and preliminary low-temperature carbonization zone: temperatures up to between 270 and 300° C.;
D—exothermal low-temperature carbonization zone: temperatures up to 400° C.;
E—heating and endothermic low-temperature carbonization zone: temperatures exceeding 520° C.;
F—calcium hydrate calcination and over heated water steam of calcium hydrate decomposition generating zone;
G—product cooling and agglomeration zone, and
H—produced agglomerate cooling and crushing zone.

Due to using very pure sugar as raw material in the form of concentrated water solution and due to using very pure ground burnt lime of very high reactivity as the reagent, during roasting of the feed at temperatures exceeding 550° C. occurs decomposition of calcium hydrate present in the feed with the creation of reactive calcium oxide and superheated steam.

Superheated steam released during calcination of millions of fine grains of calcium hydrate was directed against the flow through the porous structures of surrounding active lime coal grains extracting volatile components from the channels and pores inside the grains. This result in the final agglomerate of fine active coal and fine calcium oxide having increased absorption and impurity-binding abilities.

The above-described unique phenomenon of refining the structures of the created product has been termed “autogenic steam refinement of carbon-based sorbents.”

A micro grain mixture of active carbon and fine crystalline calcium oxide in the form of crystalline agglomerate of both components leaving the autogenic refinement zone was transported downwards the reactor and then after cooling and optional crushing or grinding was transported to a storage container.

### EXAMPLE 2

### Method of Producing Carbon-Based Sorbent

The process was conducted according to Example 1, except that instead of concentrated sugar solution dry, ground homogeneous refined sugar mixture was used and 5% w/w of ground burnt lime of very high purity and reactivity or 7% w/w of calcium hydrate were used.

### EXAMPLE 3

### Method of Producing Carbon-Based Sorbent

The process was conducted according to Example 1, except that as raw material ground homogenous organic materials were used of high purity such as sugar, starch, cellulose or organic substance of uniform chemical structure separately or as mixtures. The mixtures after being mixed with very pure active oxides or hydrates of group I, II and III elements created raw material feed for producing carbon sorbents. The carbon sorbents were for special use due to their organized structures and additional abilities of acid bonding and neutralization.

Carbon-containing substances of maximal purity and structure organization (cellulose, starch, carbohydrates, sugar and others) were used as raw material, particularly monosaccharides having from 3 to 7 carbon atoms in the backbone per molecule and polysaccharides.

Monosaccharides exist in chain or ring form if they contain at least 4 carbon atoms in the backbone per molecule. They easily crystallize and are easily soluble in water. Based on the number of carbon atoms, they can be divided into trioses, tetroses, pentoses, hexoses, heptoses, and based on the carbonyl group type into: ketoses and aldoses.

Those monosaccharides which are useful in the process are inter alia five-carbon sugars: ribose and deoxyribose and six carbon sugars: glucose, fructose, mannose, and galactose. Disaccharides, oligosaccharides, or polysaccharides useful in the process are inter alia: maltose (glucose+glucose), sucrose (glucose+fructose), and lactose (glucose+galactose).

Metal oxides and/or their hydrates present in the produced sorbent were washed with distilled water, and pure carbon products useful in further processes were obtained.

To produce such a product, to granulated dry disaccharide containing at least 99.99% of pure saccharine 10% w/w of pure reactive ground burnt lime containing at least 99.9% of CaO or 13% gravimetric of pure ground calcium hydrate Ca(OH)₂ containing at least 99.9% of hydrate were added and then the mixture was fed into the reactor. The maximum temperature in the reactor was set to 600° C. instead of 800° C.

The raw material feed was transported through the reactor areas are underwent in sequence low-temperature carbonization, high-temperature carbonization, and refinement of porous carbon structures by autogenous stream of superheated steam generated by thermal decomposition of calcium hydrate.

The product contained up to 70% w/w of reactive elementary coal having organized structure and up to 15% of reactive calcium oxide.

The product was used to produce basic nanomaterials and separately as sorbent for bonding acidic impurities from gasses and liquids.

### EXAMPLE 4

### Method of Producing Carbon-Based Sorbent

The process was conducted according to Example 2 and 3, except that granulated wet cellulose was used as the raw material. Specifically, 15% of reactive burnt lime w/w was added to granulated wet material containing 60% of cellulose w/w. The product contained up to 70% of porous active charcoal w/w and up to 30% of calcium oxide w/w. The product was used as sorbent to purify contaminated waters and acid sewage containing heavy metal compounds.

### EXAMPLE 5

The process was conducted according to Examples 2 to 4, except that various organic substances containing chemical compounds of cyclic and aliphatic structure, particularly coal tars, pitch, polymers and copolymers of cyclic and aliphatic compounds, were used as raw materials. For obtaining products of high quality with repetitive structures, it was important that the raw material contained above mentioned substances of maximal purity and repeatability of structure.

### EXAMPLE 6

The process was conducted according to Example 1 or 2, except that raw material of various degrees of purity were used.

Filters containing reactive calcium hydrate were installed in the upper portion of the reactor. As a result, effective binding occur of impurities, and particularly of acidic compounds (H₂S, SO₂; SO₃; HCl; HF and others), was observed.

### EXAMPLE 7

The process was conducted according to Examples 2 to 6, except that emphasis was placed on creating stable temperature zones.

Thermal stabilization was observed by addition to the feed of calcium, aluminium, or magnesium oxides that at the relevant temperatures exhibit low heat conduction and high specific heat.

The stabilization of thermal conditions was easier due to the presence of minerals micro grains (first hydrates, then oxides, after reaching calcination temperatures).

Porous structures of elementary carbon were characterized with high coefficient of heat conduction and low proper heat.

Due to the enormous differences in heat conduction abilities, metal oxide and hydrate grains act as thermal insulators and temperature stabilizers.

### EXAMPLE 8

The process was conducted according to Examples 1 to 7, except that a refinement process of the created elementary carbon spatial structures was conducted additionally using overheated water steam created during autogenous thermal decomposition of metal hydrates.

The basic advantage of conducting carbon structures refinement process with overheated water steam is the creation of identical conditions of water steam flow through sorbent grains (both in regard to water steam temperature as well as the intensity of the flow).

Calcium hydroxide at between 520° C. to 530° C. releases steam. The volume of the released steam depends on the amount of calcium hydroxide in the feed.

When using 20% w/w of calcium oxide and 80% w/w of sugar, each kilo of raw material batch released at least 0.217 m³ of steam at 530° C. (at the calcination temperature).

The volume of steam exceeds several times the volume of product ensuring effective removal of gaseous pyrolysis products from inside of the elementary carbon grains.

The following table exemplifies the relationship between CaO content in the feed and the volume of steam released:

| | Participation % CaO in batch w/w | | | | | | | |
|---|---|---|---|---|---|---|---|---|
| | 2 | 6 | 10 | 14 | 18 | 24 | 28 | 30 |
| Volume of generated water | 21.7 | 65.1 | 109 | 152 | 195 | 239 | 304 | 326 |
| steam in m³/Mg of processed | | | | | | | | |
| raw material batch in calcination | | | | | | | | |
| temperature of 527° C. (800° K) | | | | | | | | |

The temperatures of steam generated during hydroxide decomposition depend on the calcination temperature of the hydroxides and are, for example:

| Ca(OH)₂ | Mg(OH)₂ |
|---|---|
| 800° K | 573° K |

### EXAMPLE 9

Carbon-containing raw material feed according to Examples 2 to 8 was supplemented advantageously with insoluble hydroxides and oxides of metals having catalytic properties, such as iron, chrome, manganese, silver, copper or solutions of colloidal molecules of said metals of colloidal type of silver, gold, copper and others.

In traditional methods of such products manufacturing adding metals and metal compounds with catalytic abilities takes place only by saturation of manufactured carbon sorbent with soluble salts or by mixing ground active coals with fine-grained powders of metal compounds or powders of metals with catalytic properties. In the process with method according to the invention similar effects are reached by complementing raw material batch with solution of soluble metallic compounds or metals in form of colloidal aqueous suspensions (nano-silver, nano-gold, etc.). For example complementing condensed sugar solution with solution of soluble bivalent iron salt in example ferrous acetate and then processing received raw material batch into sorbent with the method according to the invention results in a product of very regular arrangement of catalytic substances in the created sorbent structure. Such regularity of iron oxide in the product structure unavailable with other methods.

In similar way after complementing raw material batch with nano silver solutions it is possible to produce product with unique deacidification and antiseptic properties.

### EXAMPLE 10

With the method according to the invention it was possible to receive stereo specific carbon structures preserving chains and rings structural arrangement similar to existing in the starting raw materials.

### EXAMPLE 11

Sugar mixture in the amount of 85% w/w, calcium oxide in the amount of 10% w/w and magnesium oxide in the amount of 5% w/w were processed according to the method of the invention and yield a sorbent containing 58% of active coal, 29% of calcium hydroxide and 13% of magnesium hydroxide.

The sorbent was grinded and then mixed with water to receive a mixture of 40% w/w, followed by slow bubbling of gaseous carbon dioxide through the mixture until a complete transformation of calcium and magnesium hydroxides contained in the sorbent into neutral carbonates.

Thereafter, the product was dried and granulated and then used as animal feed additive. The final product contained 50% of active carbon and 50% mineral ingredients mainly in form of calcium carbonate mixture (fine-crystalline precipitated chalk) and magnesium carbonate.

### EXAMPLE 12

To condensed sugar solution, preferably containing 85% of pure sucrose and 15% of water is added in conditions of intensive mixing 0.5% of copper hydroxide and after intensive mixing it is dried with the method according to the invention after adding 10% w/w of reactive calcium oxide.

The obtained dry granulate of raw material batch was processed into carbon sorbent. Received with this method carbon sorbent contained 70.8% C; 27.8% CaO and 1.4% CuO.

The elementary carbon sorption surface was regularly covered with copper oxide micro grains having catalytic properties.

### EXAMPLE 13

The product was manufactured according to Example 15, except that as the activating supplement aqueous phosphoric acid was used in an amount of 2.0% w/w.

The obtained product was used as an ingredient for the production of diet supplements.

### EXAMPLE 14

Ground burnt lime in an amount of 90% w/w was mixed with sugar in an amount of 10% w/w and then was subject to carbonization according to the invention yielding a product containing 97% w/w of burnt lime and 3% w/w of reactive carbon.

The obtained product was subjected to hydration with known methods using water or 20% of ethyl or propyl alcohol aqueous solutions. Porous carbon and lime sorbent was obtained containing 98% of lime hydrate and 2% of active carbon.

The product was characterized as having very active porous structure and very high sorption properties. The unexpected properties allowed the product to be used to scrub heavy metals from combustion gases.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A method of producing carbon-based sorbent, the method comprising:
(a) thoroughly mixing carbon-containing raw materials, with reagents, and optionally with reaction-influencing additives, the reagents comprising hydrates selected from hydrates of group I oxides, hydrates of group II oxides, and/or hydrates of group III oxides, to yield a homogenous intermediate, and the reaction-influencing additives comprising soluble chemical catalysts, selected from iron, silver, copper, vanadium;
(b) continuously feeding the homogenous intermediate into an upper portion of a reactor and allowing the homogeneous intermediate to flow through the reactor toward a lower portion of the reactor;
(c) carbonizing the first homogenous intermediate at low temperatures by evenly heating the upper portion of the reactor to a temperature of between 100° C. and 280° C.; carbonizing at high temperatures by evenly heating the lower portion of the reactor to between 280° C. and 500° C., whereby simultaneously dehydrating the hydrate(s), and forming within the grains of the hydrate(s) autogenous micro reactors, and whereby releasing superheated dry steam at high temperature exceeding 500° C.;
(d) directing the superheated dry steam against the direction of the flow of the homogeneous intermediate; and
(e) obtaining carbon-based sorbent in the lower portion of the reactor and continuously removing the carbon-based sorbent from the reactor.

2. The method of claim 1, wherein the carbon-containing raw materials are beet sugar in the form of aqueous solution comprising from 50-90% w/w of sugar, and the reagent is ground burnt lime having t₆₀<2 minutes in an amount of from 5 to 30% w/w.

3. The method of claim 1, wherein the carbon-containing raw materials are dry, ground homogeneous refined saccharide mixture, and the reagent is a ground burnt lime of very high purity and reactivity or calcium hydrate of very high purity.

4. The method of claim 1, wherein the carbon-containing raw materials are saccharide, starch, and/or cellulose.

5. The method of claim 1, wherein the carbon-containing raw materials are monosaccharides and/or polysaccharides

6. The method of claim 1, wherein the carbon-containing raw materials are glycerin, ribose, deoxyribose glucose, fructose, mannose and galactose.

7. The method of claim 1, wherein the carbon-containing raw materials are disaccharides, oligosaccharides, or polysaccharides.

8. The method of claim 1, wherein the carbon-containing raw materials are dry sugar of 99.99% purity, and the reagents are pure reactive ground burnt calcium, containing at least 99.9% of CaO or pure ground calcium hydrate Ca(OH)₂, containing at least 99.9% of hydroxide.

9. The method of claim 1, further comprising removing metal oxides and/or their hydrates by rinsing with solvents.

10. The method of claim 1, wherein the carbon-containing raw materials are refined coal tars, pitch, polymers or copolymers of cyclic or aliphatic compounds.

11. The method of claim 1, further comprising admixing to the homogeneous intermediate heat resistant metal elements selected from balls, rings, cylinders of various sizes or similar elements made of heat resistant chemical compounds, selected from calcium, aluminium, or magnesium oxides.

12. The method of claim 1, wherein controlling the amount of generated steam by adjusting the amount of oxide or hydroxide in the raw material and adjusting the temperature by changing the reagent.

13. The method of claim 1, wherein the reaction-influencing additives are selected from zinc, iron, chromium, vanadium, nickel, cobalt, manganese, silver, molybdenum, gold, copper or solutions of colloidal molecules of said metals.

14. The method of claim 1, wherein the reaction-influencing additives are metals or metalloids, in shredded form and/or in form of aqueous salts solutions.

15. The method of claim 1, further comprising suspending the sorbent in water and passing gaseous carbon dioxide through the resultant suspension whereby converting metal hydroxides incorporated into the sorbent into unreactive carbonates.

16. The method of claim 1, wherein the reaction-influencing additives are selected from zinc, iron, copper, chrome, vanadium, nickel, cobalt, manganese, molybdenum, silver, gold, and platinum in form of colloidal particles of said metals and/or their chemical compounds.

17. The method of claim 1, wherein comprising further admixing to the raw materials stricken or woven spatial scaffold structures made of heat resistant steel.

18. The method of claim 17, wherein the scaffold structures are of circular, rectangular, oval or polygonal cross-section, and have been treated with chemical compound solutions facilitating adherence of the raw materials.

19. The method of claim 18, wherein the scaffold structures are pumice, bentonite, sintered aluminium or expanded clay aggregate.
